(19) United States
(12) Patent Application Publication
(10) Pub. No.: US 2009/0196574 A1
(43) Pub. Date: Aug. 6, 2009

(54) Still Image Promotion

(76) Inventor: James M. Lidestri, Hopewell Junction, NY (US)

Correspondence Address: FISH & RICHARDSON P.C., P.O BOX 1022, Minneapolis, MN, 55440-1022, US

(21) Appl. No.: 12/367,259

(22) Filed: Feb. 6, 2009

Related U.S. Application Data
(60) Provisional application No. 61/026,617, filed on Feb. 6, 2008.

(51) Int. Cl. H04N 5/91

(52) U.S. Cl. 386/68

(57) ABSTRACT

A computer-implemented method of providing a slideshow representation of video content. The method includes storing video content in memory, playing the video content in real time, capturing a plurality of still images from the content as the video content is played to provide a set of captured images, selecting a plurality of the captured images to generate a series of selected images, and generating the slideshow based on the selected images.

### CROSS-REFERENCE TO RELATED APPLICATION

The present application claims priority to U.S. Prov. Pat. App. No. 61/026,617, filed on Feb. 6, 2008, under 35 U.S.C. §119(e). U.S. Prov. Pat. App. No. 61/026,617 is expressly incorporated herein by reference in its entirety for all purposes.

### TECHNICAL FIELD

The present disclosure relates to video content, and more particularly to providing a still image representation of video content.

### BACKGROUND

The advent of the Internet has enabled the transfer of information and data to millions of users worldwide. The Internet has also enabled electronic commerce, or e-commerce, which includes the buying and selling of products and/or services over electronic systems such as the Internet, and other computer networks. The amount of electronic trade has rapidly grown over the last decade or so.

Products that are sold through e-commerce can include creative works that are provided in electronic form. Such creative works can include digital writings (e.g., books, papers, articles), digital documents (spreadsheets, databases, files), software applications, images, photos and videos. Digital creative works can be advertised online through a seller website, for example, and can be electronically transferred to a buyer, upon purchase. Payment for the digital creative works can be made using electronic transfer of funds. Some websites enable users to post their own creative works for sale, or creative works, in which the particular user has rights to post for sale. In some instances, it is desirable for only a portion of the creative work to be displayed prior to providing full access to a viewer.

### SUMMARY

The present disclosure is directed to computer-implemented methods, computer readable medium, and systems for providing a slideshow representation of video content. In some implementations, a computer-implemented method includes storing video content in memory, playing the video content in real time, capturing a plurality of still images from the content as the video content is played to provide a set of captured images, selecting a plurality of the captured images to generate a series of selected images, and generating a slideshow based on the selected images.

In some implementations, the method further includes providing a website-based tool to achieve the playing and the capturing.

In some implementations, the playing is achieved using a digital video player that is provided as executable software, the digital video player including functionality to capture the plurality of still images.

In some implementations, the method further includes providing a clickable trigger within a display to initiate the capturing. Capturing an image can be achieved with each click of the clickable trigger. In other implementations, a capture routine can be initiated by clicking the clickable trigger, and the capture routine can be halted by clicking the clickable trigger.

In some implementations, the method further includes displaying the set of captured images, and copying selected images of the set of captured images to predefined spaces in a sample set display.

In some implementations, the method further includes playing a plurality of video content, and concurrently processing each of the plurality of video content to generate respective series of selected images, wherein the processing includes the capturing. Settings can be stored to memory, wherein the concurrent processing is achieved based on the settings.

In some implementations, the capturing comprises executing a capture routine during the playing. Images are automatically captured based on time-based criteria.

In some implementations, the method further includes adjusting a quality setting. An image quality of each of the plurality of still images is based on the quality setting.

In some implementations, the method further includes storing the slideshow to memory, accessing the slideshow from memory, editing the slideshow to provide an edited slideshow, and storing the edited slideshow to memory.

In other implementations, a computer-implemented method includes storing a plurality of video content in memory, playing one or more of the plurality of video content using a digital tool, initiating a capture routine using the digital tool, and capturing a plurality of still images as the one or more of the plurality of video content is played to provide a respective set of captured images. The respective set of captured images is displayed, and selected images of the respective set of captured images are copied to predefined spaces in a sample set display. A slideshow is generated based on images of the sample set display.

In still other implementations, a computer-implemented method includes storing a plurality of video content in memory, concurrently playing the plurality of video content using a digital tool, initiating a capture routine using the digital tool, and capturing a plurality of still images as the plurality of video content is played to provide respective sets of captured images. The respective sets of captured images are displayed, and selected images of each of the respective sets of captured images are copied to predefined spaces in respective sample set displays. Respective slideshows are generated based on images of the respective sample set displays.

A computer readable medium can be encoded with a computer program comprising instructions that, when executed, operate to cause a computer to perform operations in accordance with implementations of the computer-implemented method of the present disclosure.

A system can include a network, and a computer that communicates over the network. The computer can include a computer-readable medium encoded with a computer program comprising instructions that, when executed, operate to cause a computer to perform operations. The operations are provided in accordance with implementations of the computer-implemented method of the present disclosure.

The details of one or more implementations of the present disclosure are set forth in the accompanying drawings and the description below. Other features, objects, and advantages of the invention will be apparent from the description and drawings, and from the claims.

### DESCRIPTION OF DRAWINGS

FIG. 1 is a functional block diagram of an exemplar computer system.

FIG. 2 is an exemplar screen-shot in accordance with some implementations of the present disclosure.

FIG. 3 is a flowchart illustrating exemplary steps executed in accordance with some implementations of the present disclosure.

### DETAILED DESCRIPTION

The present disclosure is directed to a process for creating a digital still image slideshow to represent a digital video clip or movie. Applications include situations where showing the entire video clip or movie, or a subset of the video clip or movie is not technically feasible, not practical, or is not appropriate. A showing of the video clip or movie may be inappropriate in cases where the video clip or movie include sexually explicit content, offensive content, brand names/trademarks, and personally identifiable information such as names, license plates, ID's, and the like. The various embodiments of the process described herein can be run on mobile devices such as laptop computers, cell phones, PDAs, tablet computers, and/or other mobile devices, as well as on other consumer electronic devices such as personal computers, set top boxes, DVR's, media terminals, TV control devices, gaming consoles, and/or home automation systems.

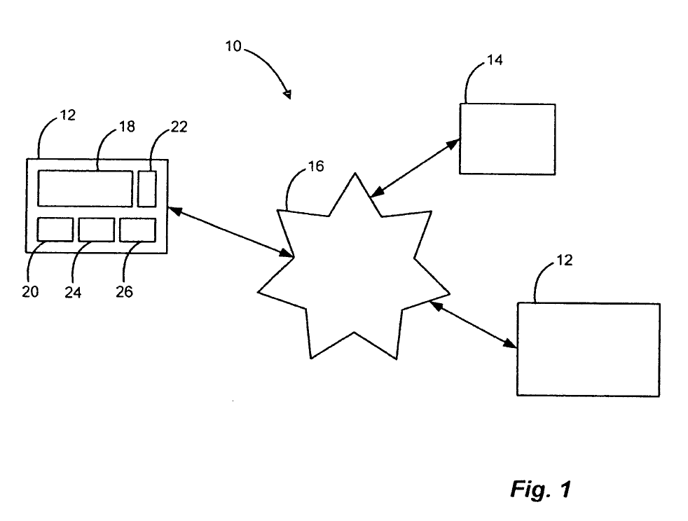

Referring now to FIG. 1, an exemplar system for implementing the process of the present disclosure is illustrated. An exemplary computer network 10 includes a plurality of computers 12, and one or more servers 14 that communicate with one another over a network 16. The network 16 can include, but is not limited to, a local area network (LAN), a wide area network (WAN), and/or the Internet. An exemplary computer 12 includes a display 18, an input device 20, such as a keyboard and/or mouse, memory 22, a dataport 24, and a central processing unit (CPU) 26. The display 18 can include a CRT (cathode ray tube) or LCD (liquid crystal display) monitor for displaying information to the user. The input device 20 can include a keyboard, and/or a pointing device such as a mouse or a trackball, by which the user can provide input to the computer 12. Other kinds of devices can be used to provide for interaction with a user as well; for example, input from the user can be received in any form, including acoustic, speech, or tactile input.

A software program or computer program product that executes one or more implementations of the present disclosure can be resident on one or more of the computers 12, and/or on the server 14. For example, the software program can be resident on a particular computer 12, which the user implements to select content, capture images, and generate the slideshow. Additionally, or in the alternative, the user can access a website through the network 16. The user performs the content selection, image capturing, and slideshow generation, as described above, using the website.

Implementations of the processes of the present disclosure enable a user to select content, for which a slideshow is desired. The content can be a particular video clip or movie, or subset of a video clip or movie. While viewing the content, a command is issued to create a still image snapshot of the content at a desired moment, thereby creating a captured image. The command can be issued by the user. This is repeated through the viewing of the content, and a series of captured images is generated. The user can select one or more of the captured images to be included in a slideshow of user-selected images. Accordingly, the slideshow is generated as a sub-set of the series of captured images. The slideshow is subsequently stored. In some embodiments, the user isn't required to select which images to include in the slideshow, and the slideshow is provided as the series of captured images, as opposed to a sub-set thereof.

The user can be able to selectively delete one or more of the captured images from the series of captured images to generate the slideshow. Further, or in the alternative, the user can be able to selectively delete one or more of the selected images that make up the slideshow. In other embodiments, the user is able to select the order of the selected images to be presented in the slideshow.

A plurality of frames can be captured when the command is issued to take a snapshot. For example, the user can define the number of frames to capture per command issue. In an alternative example, the user can define a period of time after issuing the command, during which frames are captured. For example, each time the command is issued to select a snapshot, X frames are captured, or Y frames are captured in the subsequent Z period of time (e.g., seconds).

Images can be captured based on user determined criteria. Exemplar criteria include, but are not limited to, a per time period basis, a per time interval basis, and/or a per scene basis. In the per time period basis, a time period or time periods can be user defined. For example, the time period can include every 5 seconds for the entire clip. As an alternative, multiple time periods can be defined. For example, the first 5 seconds, the next 30 seconds and so on. The user can define the number of captures to be collected for each time period. In the per time interval basis, the user can define a time interval, or time intervals. For example, the time interval can include every third of the video clip. As an alternative, multiple time intervals can be define (e.g., the first 10% of the video clip, the next 25% of the video clip, etc.). The user can select the number of captures to be collected for each time interval. In the per scene basis, the user defines the number of captures to be collected for each scene change. More specifically, a scene change is detected in the content, and new captures are taken upon a change in scene.

The embodiments described above can be executed both in real-time (i.e., in front of the user), or in batch (i.e., an automated background process). Batch processing can be applied to multiple content files that are concurrently processed. Further, the user-defined options can be saved for future use.

The selected images that make up the slideshow can be edited. For example, titles, title effects (e.g., wipes, fades, etc.), text, text effects (e.g., fonts, sizes, colors, underline, bold, shadow, etc.), graphics, and/or graphic effects (e.g., place images, graphics, backgrounds, themes, etc.) can be added. Further, or in the alternative, privacy screens, and effects to cover any areas of the selected images that the user wishes to hide from view, as well as photo effects (e.g., soften, blur, contrast, sepia, hue, saturation, etc.) can be applied. Further, the image or images can be re-oriented (e.g., rotate, zoom in and out), and/or slideshow effects can be applied (e.g., the nature of the way the images transition to one another). The user-defined options can be saved for future use.

Transport controls can also be provided to control the viewing of the content. Exemplar transport controls include, but are not limited to, play, stop, step ahead, step back, fast forward, rewind and/or pause. Further, a time slider can be manipulated manually by the user to quickly navigate through the content. A time search feature can be provided that enables the user to enter a time code so that the content will be shown at that requested position of the video or clip (e.g. at the 00:01:15:29 mark).

The user can add audio to the slideshow. The audio can be user-provided, or can be pre-defined and user selectable. For example, the user can select one or more audio clips provided from a list of audio clips. Further, the original audio of the content can be captured, or recorded, and can be used as background audio in the slideshow.

The captured images and/or selected images that make up the slideshow can be saved for future use. In this manner, one or more other slideshows can be created from the captured images. Further, searching and sorting routines can be provided to enable the user to navigate and select previously stored captured images.

The user can apply a quality setting for the image capture. For example, the quality setting can range from low to high with high being the highest quality capture possible. In this manner, low quality images can be captured to conserve memory, or high quality images can be captured to provide enhanced detail.

Furthermore, additional information for each of the captured images can be provided and stored. Exemplar information can include, but is not limited to, frame number, time code, original recording date and time, content title, and/or content file name.

It is contemplated that a variety of choices in file formats and sizes can be provided for storing the slideshow. Additionally, quality settings can be applied to the slideshow for storing.

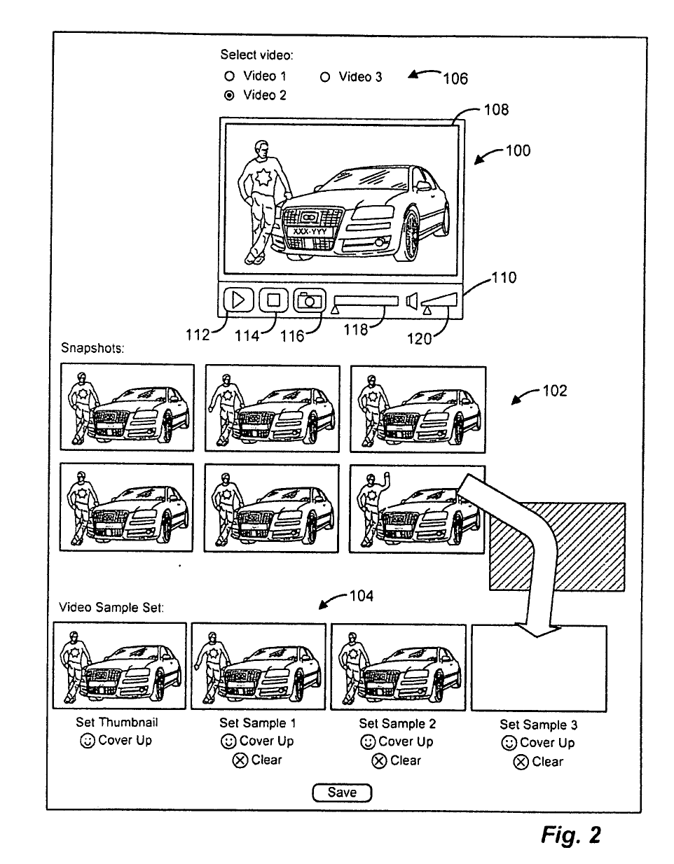

Referring now to FIG. 2, an exemplar screen-shot illustrates an implementation of the present disclosure, and includes a video display 100, a snapshot display 102, and a sample set display 104. The video display 100 can be provided as an embedded video player. The particular video that is displayed within the video display 100 can be selected by the user in any number of manners. In the exemplar illustration of FIG. 2, the user is provided with a list of videos 106, from which to select (e.g., “Video 1,” “Video 2,” and “Video 3”). The list of videos 106 can be generated based on a user profile that is stored by a provider. For example, the provider can include a website proprietor that provides an online environment (e.g., “www.genericwebsite.com”) for a user to exhibit and/or offer for sale digital content. For example, the user can create a profile on the provider's website, and can upload digital content to the website. An exemplar profile is described in U.S. patent application Ser. No. 12/355,280, filed on Jan. 16, 2009, the disclosure of which is expressly incorporated herein by reference in its entirety. The user can access the profile through the provider's website, and can build a collection of digital content associated with the profile. The digital content can include videos, which videos are automatically populated to the list of videos from the user profile information.

The exemplar video display 100 of FIG. 2 includes a display section 108 and a control section 110. The display section 108 displays a user selected video, and the control section 110 controls the display of the video. Controls provided in the control section can include, but are not limited to, a play button 112, a stop button 114, a snapshot button 116, a slider bar 118, and/or a volume control 120. A user can cause the video to play by clicking on the play button 112, can stop the video by clicking on the stop button 114, and forward and rewind through the video using the slider bar 118, and can adjust a volume of the video using the volume control 120.

The user can use the snapshot button 116 to generate a set of still images, or snapshots from the video. In the exemplar illustration of FIG. 2, the snapshot display 102 can be initially provided as a blank display without snapshots populated therein. The user can generate snapshots, which populate the snapshot display 102. In some implementations, the user can click the snapshot button 116, while the video is playing in the display section 100. At each click, a snapshot of the video is taken and populates the snapshot display 102 with a still image of the video. In other implementations, a single click of the snapshot button 116 initiates a sampling process, through which a series snapshots of the video are automatically generated. For example, the sampling process can execute on a per time period basis, a per time interval basis, and/or a per scene basis, as discussed in detail above. In such implementations, a second click of the snapshot button 116 can halt the sampling process. After populating the snapshot display 102 with a desired number of snapshots, the user can save the snapshots to memory as a set, which set can be later accessed.

The user can populate the sample set display 104 with select snapshots from the generated snapshot set. In some implementations, a pre-determined number of spaces is provided in the sample set display 104. The user can drag a snapshot from the snapshot set and drop the snapshot into a space of the sample set display 104, as illustrated in FIG. 2, to create a sample set. In other implementations, the desired snapshots can be highlighted, or otherwise selected, and automatically added to corresponding spaces of the sample set display 104.

A cover-up option is provided to enable a user to cover up content within each snapshot, which content the user does not want to make available for public view. Exemplar methods and systems for providing cover-up are disclosed in co-pending U.S. patent application Ser. No. 12/354,967, filed on Jan. 16, 2009, the disclosure of which is expressly incorporated herein by reference in its entirety. Such methods and systems enable the user to easily and quickly cover an area of the content within the snapshots that the user does not wish to be seen by viewers. Exemplar applications include, but are not limited to, masking sexually explicit content, offensive content, brand names, trademarks and personally identifiable information that can include, but is not limited to, names, license plates, identification documents, faces, body parts, houses, cars, airplanes, boats, furniture, artwork, home furnishings, landmarks, and the like.

The populated sample set can be saved to memory for subsequent access. The sample set can be used to advertise particular content in an online environment. For example, the provider can display the user's sample set in an online environment for viewer access. In this manner, the sample set provides an abridged view of the content, which a viewer may seek to purchase and/or access.

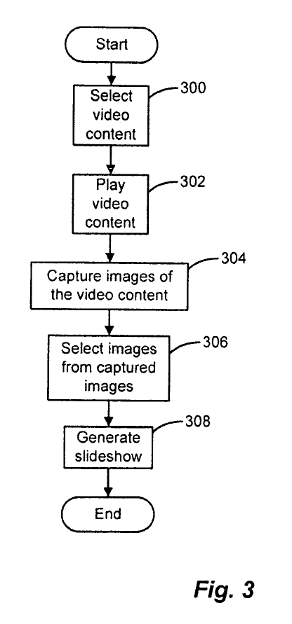

Referring now to FIG. 3, exemplar steps that can be executed in implementations of the present disclosure will be described in detail. In step 300, the video content is selected. As discussed above, the video content can be selected from a plurality of video content stored in memory. In step 302, the video content is played. In some implementations, the video content can be played using a website-based video player that provides an image capturing tool. Images of the video content are captured in step 304. In step 306, images are selected from the captured images to provide a series or sub-set of captured images provided as selected images. A slideshow is generated based on the selected images in step 308. The exemplar steps can be implemented in batch processing of multiple videos to concurrently generate respective pluralities of captured images.

Implementations of the present disclosure can be realized through digital electronic circuitry, or in computer hardware, firmware, software, or in combinations thereof. The invention can be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Implementations of the present disclosure can be performed by one or more programmable processors executing a computer program to perform functions of the invention by operating on input data and generating output. Processes can also be performed by, and apparatus can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks. The processor and the memory can be supplemented by, or incorporated in special purpose logic circuitry.

Processes of the present disclosure can be implemented in a computing system that includes a back-end component, e.g., as a data server, or that includes a middleware component, e.g., an application server, or that includes a front-end component, e.g., a client computer having a graphical user interface or an Web browser through which a user can interact with an implementation of the invention, or any combination of such back-end, middleware, or front-end components. The components of the system can be interconnected by any form or medium of digital data communication, e.g., a communication network. Examples of communication networks include a local area network, a wide area network, and the Internet.

A number of implementations of the disclosure have been described. Nevertheless, it will be understood that various modifications may be made without departing from the spirit and scope of the disclosure. More specifically, implementations of the method and system of the present disclosure can include various combinations of the features described herein. For example, implementations of the method and system can include a plurality of the features described herein, while other implementations can include all of the features described herein.

What is claimed is:

1. A computer-implemented method of providing a slideshow representation of video content, comprising:
storing video content in memory;
playing the video content in real time;
capturing a plurality of still images from the content as the video content is played to provide a set of captured images;
selecting a plurality of the captured images to generate a series of selected images; and
generating the slideshow based on the selected images.

2. The method of claim 1, further comprising providing a website-based tool to achieve the playing and the capturing.

3. The method of claim 1, wherein the playing is achieved using a digital video player that is provided as executable software, the digital video player including functionality to capture the plurality of still images.

4. The method of claim 1, further comprising providing a clickable trigger within a display to initiate the capturing.

5. The method of claim 4, further comprising capturing an image with each click of the clickable trigger.

6. The method of claim 4, further comprising:
initiating a capture routine by clicking the clickable trigger; and
halting the capture routine by clicking the clickable trigger.

7. The method of claim 1, further comprising:
displaying the set of captured images; and
copying selected images of the set of captured images to predefined spaces in a sample set display.

8. The method of claim 1, further comprising:
playing a plurality of video content; and
concurrently processing each of the plurality of video content to generate respective series of selected images, wherein the processing includes the capturing.

9. The method of claim 8, further comprising storing settings to memory, wherein the concurrent processing is achieved based on the settings.

10. The method of claim 1, wherein the capturing comprises executing a capture routine during the playing, and wherein images are automatically captured based on time-based criteria.

11. The method of claim 1, further comprising adjusting a quality setting, wherein an image quality of each of the plurality of still images is based on the quality setting.

12. The method of claim 1, further comprising:
storing the slideshow to memory;
accessing the slideshow from memory;
editing the slideshow to provide an edited slideshow; and
storing the edited slideshow to memory.

13. A computer-implemented method of providing a slideshow representation of video content, comprising:
storing a plurality of video content in memory;
playing one or more of the plurality of video content using a digital tool;
initiating a capture routine using the digital tool;
capturing a plurality of still images as the one or more of the plurality of video content is played to provide a respective set of captured images;
displaying the respective set of captured images;
copying selected images of the respective set of captured images to predefined spaces in a sample set display; and
generating the slideshow based on images of the sample set display.

14. The method of claim 13, wherein the digital tool is one of a website-based tool and a software-based tool executed on a device.

15. The method of claim 13, wherein the capture routine includes capturing a still image with each click of a clickable icon provided in the digital tool.

16. The method of claim 13, wherein the capturing comprises executing a capture routine during the playing, and wherein images are automatically captured based on time-based criteria.

17. The method of claim 13, further comprising:
playing a plurality of video content; and
concurrently processing each of the plurality of video content to generate respective series of selected images, wherein the processing includes the capturing.

18. The method of claim 17, further comprising storing settings to memory, wherein the concurrent processing is achieved based on the settings.

19. The method of claim 13, further comprising adjusting a quality setting, wherein an image quality of each of the plurality of still images is based on the quality setting.

20. A computer-implemented method of providing slideshow representations of video content, comprising:
storing a plurality of video content in memory;
concurrently playing the plurality of video content using a digital tool;
initiating a capture routine using the digital tool;
capturing a plurality of still images as the plurality of video content is played to provide respective sets of captured images;
displaying the respective sets of captured images;
copying selected images of each of the respective sets of captured images to predefined spaces in respective sample set displays; and
generating respective slideshows based on images of the respective sample set displays.
